(19) United States
(12) Patent Application Publication
(10) Pub. No.: US 2012/0329628 A1
(43) Pub. Date: Dec. 27, 2012

(54) FOLDING APPARATUS FOR FOLDING OF NON-RIGID MATERIAL PARTS

(75) Inventors: Christian ABT, Eislingen (DE); Dieter FAUDE, Gaertringen (DE)

(73) Assignee: ROFOBOX GMBH, Kornwestheim (DE)

(21) Appl. No.: 13/534,733

(22) Filed: Jun. 27, 2012

Related U.S. Application Data
(63) Continuation-in-part of application No. PCT/EP2010/070763, filed on Dec. 27, 2010.

(30) Foreign Application Priority Data
Dec. 28, 2009 (DE) 10 2009 060 965.2

(51) Int. Cl. B31F 1/00

(52) U.S. Cl. 493/416

(57) ABSTRACT

A folding apparatus for folding of non-rigid material parts has a folding unit for folding of individual non-rigid material parts, a storage unit for receiving the folded non-rigid material parts from the folding unit, a supply unit for keeping non-folded non-rigid material parts on hand, and a transport unit for feeding the non-folded non-rigid material parts from the supply unit to the folding unit, and a provisioning unit keeping set items on hand for the folding unit. The provisioning unit has a withdrawal unit for storage of unsorted set items and a deposit unit for receiving sorted set items.

### CROSS-REFERENCE TO RELATED APPLICATIONS

Applicants claim priority under 35 U.S.C. §119 of German Application No. 10 2009 060 965.2 filed on Dec. 28, 2009. This application is also a continuation of and Applicants claim priority under 35 U.S.C. §120 of International Application No. PCT/EP2010/070763 filed on Dec. 27, 2010 which claims priority under 35 U.S.C. 119 of German Application No. 10 2009 060 965.2 filed on Dec. 28, 2009. The international application under PCT article 21(2) was not published in English. The disclosure of the aforesaid International application and German application are incorporated by reference.

### BACKGROUND OF THE INVENTION

1. Field of the Invention

The invention relates to a folding apparatus for folding of non-rigid material parts as well as components for it.

2. The Prior Art

Numerous napkin folding apparatuses are known, with which non-rigid napkins can be folded. For example, German Patent Application No. DE 199 38 344 C1 describes a folding unit structured as a flatware roll-up unit, which is provided for folding or rolling of individual napkins, a storage unit structured as a collection compartment, which is provided for receiving the folded napkins from the folding unit, a supply unit structured as a napkin provisioning station, which is provided for making non-folded napkins available, a transport unit that is provided for feeding the non-folded napkins from the supply unit into the folding unit, and a provisioning unit structured as a flatware provisioning station, which is provided for keeping flatware on hand for the folding unit. The non-folded napkins are kept on hand in the napkin provisioning station. The transport unit takes the individual napkins from this station, little by little, in order to feed them to the flatware roll-up station. In the flatware roll-up station, the flatware is completely rolled up into the napkin, secured with a napkin closure, and released into the collection compartment.

U.S. Pat. No. 2,025,246 describes a napkin folding apparatus which has a folding unit provided for folding of individual napkins, a storage unit provided for receiving the folded napkins from the folding unit, a supply unit for keeping non-folded napkins on hand, and a transport unit provided for conveying the non-folded napkins from the supply unit to the folding unit. In the supply unit, the non-folded napkins are kept on hand in a stack. A gripping system of the transport unit then removes the individual napkins, little by little, to convey them to the folding unit.

U.S. Pat. No. 1,371,349 describes a napkin folding apparatus which has a folding unit provided for folding of individual napkins and a storage unit provided for receiving the folded napkins from the folding unit. A single non-folded napkin is manually conveyed to the folding unit. In the folding unit, the individual napkin is then folded in a double-wall housing and, from there, conveyed to the storage unit by way of rollers.

U.S. Pat. No. 4,865,579 describes a napkin folding apparatus having a folding unit provided for folding of individual napkins. The folding unit comprises multiple folding devices for multiple folding of the individual napkins, whereby the folding devices come into use one after the other. Each folding device folds an individual napkin along a predetermined axis.

A napkin folding apparatus is known from JP-A-07275600, whose folding unit serves for folding of individual napkins into a zigzag shape. For this purpose, the napkin is laid onto a receiving table having recesses. For folding into a zigzag shape, the napkin is pressed into the recesses by the folding unit.

An apparatus for rolling flatware up into a paper napkin is known from U.S. Pat. No. 5,469,688 A. The rolling-up process takes place at a transfer location at which the flatware is rolled up into the paper napkin. For this purpose, the flatware and the napkin are transported to the transfer location by means of a distributor. A transport unit for transport of metallic flatware by means of a magnet is known from U.S. Pat. No. 5,019,112 A. In order to be able to present the flatware in an unmixed and aligned manner, a flatware sorting machine is described in U.S. Pat. No. 3,394,804 A, which has a rotating table to which unsorted flatware is conveyed at the center, which is then conveyed to a receiving container in unmixed and aligned manner, can be used.

### SUMMARY OF THE INVENTION

It is an object of the invention to indicate a napkin folding apparatus with which a significant improvement in the folding of napkins is made possible. Likewise, components for this are supposed to be created.

This object is accomplished according to the invention by an apparatus for folding or handling of non-rigid material parts having a folding unit that is provided for folding of individual non-rigid material parts, a storage unit that is provided for receiving the folded non-rigid material parts from the folding unit, a supply unit that is provided for keeping non-folded non-rigid material parts on hand, and a transport unit that is provided for feeding the non-folded non-rigid material parts from the supply unit to the folding unit. There is a provisioning unit that is provided for keeping set items on hand for the folding unit. The provisioning unit comprises a withdrawal unit for storing unsorted set items and a deposit unit for receiving sorted set items. In this connection, “unit” should particularly be understood to mean an overall unit that can also consist of multiple individual units. Napkins can be provided as non-rigid material parts, for example. Other non-rigid material parts can be, for example, rags, cloths, packaging sleeves, etc., made of textile, plastic, paper, leather, or also rubber parts such as O-rings or the like. Set items can be parts of the same type or of different types, which are added to the non-rigid material part, whereby, for example, they can be laid into the folded non-rigid material part or affixed to the folded non-rigid material part.

It is particularly advantageous to keep unsorted loose set items on hand in the withdrawal unit, which are automatically sorted and conveyed to the folding unit. In this way, simple and fast outfitting of non-folded non-rigid material parts with set items in the folding unit is possible, and subsequently, simple removal of the finished, folded non-rigid material parts, outfitted with set items, to be placed in the storage unit, can be carried out. Great numbers of non-rigid material parts with set items can be folded at constantly the same quality, within a short period of time, because the folding and outfitting process can take place almost automatically. Only a few manual activities, such as, for example, outfitting the provisioning unit with loose set items, outfitting the supply unit with non-folded non-rigid material parts, or removal of filled stacks of boxes from the storage unit or conveying empty stacks of boxes to the storage unit are required, and these activities only have to take place at great time intervals. In particular, outfitting of the provisioning unit can mean that the set items are conveyed or laid in in the correct position, or can be introduced into the provisioning unit as bulk material, without adhering to a position direction. In this connection, outfitting the provisioning unit with bulk material, in other words without any manual orientation of the set items, is particularly work-saving. By means of the concentrated spatial arrangement of the interacting units, loading of the withdrawal unit and withdrawal of the set items from the withdrawal unit, with subsequent orderly correct deposit on the deposit unit can take place simultaneously in this way, thereby resulting in significant time savings. In this way, outfitting of the folding unit with large numbers of sorted set items is possible within a short time. In particular, the provisioning unit allows short paths of the set items to the folding unit, thereby saving not only construction space but also costs. Operation of the folding apparatus is therefore possible even over an extended period of time, without manual intervention. It is particularly advantageous if the folding apparatus is configured as a napkin folding apparatus in which napkins are folded as non-rigid material parts, and are outfitted with flatware as set items.

A particular advantage of the invention consists in that the non-rigid material parts are folded not only two-dimensionally, but also their shape can be configured three-dimensionally, i.e. that the individual non-rigid material parts can be brought into a desired spatial shape.

Preferably, the folding apparatus has a conveying unit for conveying the set items from the withdrawal unit to the deposit unit of the provisioning unit. In this way the set items are selected in a targeted manner, transported in a secure and gentle manner, and deposited on the deposit unit in a controlled manner. Thus, the folding unit always has sufficient sorted set items available to it, and guarantees a problem-free work cycle during operation. In this connection, feed and direct placement of the set items into the non-rigid material part can take place, as can feed of the set items and placement into the deposit unit, which forms a storage/buffer, in order to have a corresponding supply of sorted set items disposed in the correct position, if, for example, the desired set item, for example a fork or the like, is randomly unavailable in the bulk goods for an extended period of time. In both cases, the set items can be recognized and transported by way of a sensor system, particularly by a handling system, for example a robot.

It is practical if the conveying unit has a gripping and/or winding system and/or a hold-down system and/or a bracket system. In an advantageous manner, the conveying unit is configured so that differently configured tools having different functions are available, as replacements, in order to be able to perform various work steps during the folding and outfitting process of the non-rigid material parts. Because the conveying unit automatically changes the various systems, constant operation occurs, with a handling volume that can be calculated.

In a further development, the gripping and/or winding system and/or the bracket system and/or the hold-down system is/are configured as a tool system of a handling system, for example of a robot. The gripping system can be configured in such a manner that even more complicated folding and winding techniques can be carried out, thereby making it possible to automatically produce the most varied shapes of non-rigid material parts with set items. Alternatively or in addition, a corresponding fold-over mechanism can also be provided.

The winding system can be structured as a tool system of the handling system, for example of a robot, or can have a separate drive. It is particularly advantageous if the winding process of the non-rigid material parts can alternatively be carried out with a price-advantageous separate drive. This alternative embodiment can be used as a price-advantageous alternative to the handling system. Furthermore, the separate drive can also be used as an additional work unit, along with the active handling system, in order to increase the handling volume of the non-rigid material parts outfitted with set items during peak demand.

It is advantageous if the folding apparatus has a magazine that is provided for keeping tool systems for the conveying unit on hand. In this way, the conveying unit has access to different tools in the magazine, which are used during operation, during the folding and outfitting process of the non-rigid material parts. An undisturbed work cycle is made possible by the spatially close availability of the tool systems in the magazine. Furthermore, the systematic and space-saving arrangement of the different tools allows short transport paths to the folding unit and thereby savings in time and costs.

In a further development, the conveying unit has a changing system for changing of tool systems kept on hand in the magazine. The changing system comprises an adapter on the handling system side and an adapter on the tool side. Preferably, this involves a plug-in system on the handling system side and on the tool side, in the form of adapters, which allows rapid and reliable tool replacement for the handling system, for example a robot. Such tool changers are known in mechanical engineering.

In another embodiment, the supply unit provided for provisioning of non-folded non-rigid material parts comprises a conveyor belt guided along an advancement path in a circulation direction, to be filled with non-folded non-rigid material parts. In particular, the conveyor belt allows short paths of the non-rigid material parts to the folding unit, thereby saving both time and construction space. In this way, simple outfitting of the folding unit with large amounts of non-folded non-rigid material parts and simple removal of the non-rigid material parts from the supply unit is possible, thereby resulting in significant time savings in the folding of non-rigid material parts. Furthermore, in this way reliable and gentle transport of non-folded non-rigid material parts to the folding unit is possible.

Preferably, the folding unit provided for folding of individual non-rigid material parts is configured as a table that is provided with a friction coating and/or a counter-sinkable fixation unit and/or a partial vacuum device and/or a separation apparatus and/or a hold-down apparatus. The table serves not only for receiving non-folded non-rigid material parts, particularly napkins, but also for accommodation and integration of various functional devices, such as, for example, fixation devices and separation apparatuses.

It is practical if the table and/or the folding unit and/or the gripping unit is/are structured to be rotatable. The table and/or the folding unit and/or the gripping unit can therefore be positioned freely and thereby reduce the programming effort of the handling systems, for example one or more robots.

Another advantageous further development of the invention provides that the transport unit provided for conveying the non-folded non-rigid material parts from the supply unit to the folding unit has a gripping and/or winding system and/or a bracket system and/or a hold-down system. The transport unit can be configured in such a manner that even complicated shapes of non-rigid material parts can be produced automatically. It is particularly advantageous that the individual non-rigid material part can be transported from the supply unit to the folding unit in a rapid but nevertheless gentle manner.

Particularly preferably, the gripping and/or winding system and/or the bracket system and/or the hold-down system is/are configured as a tool system of a handling system, for example of a robot. The handling system can accommodate the various tool systems and thereby perform a plurality of movement sequences, in order to also carry out complicated folding and winding techniques, so that many desired shapes can be produced. Thus, the tool system of the transport unit functions as a supportive supplement to the handling system of the folding unit.

In one embodiment, the gripping and/or winding system is configured as a needle and/or Bernoulli-Venturi and/or Coanda and/or mechanical gripping system and/or finger gripping system and/or jaw gripping system. In this way, secure gripping and moving of the individual non-rigid material part is possible, in particular, so that the steps of the folding and winding techniques can in fact be implemented or performed, and thereby operation can take place without interruptions. Uniform quality of the rolled-up non-rigid material parts with set items is guaranteed by means of a gripping and/or winding system configured in this manner.

In another embodiment, the gripping system is connected with the handling system, for example a robot, or a frame construction of the folding apparatus, by way of a press-down unit. The press-down unit exerts a defined pressure on a stack of non-rigid material parts, for example a stack of napkins or a stack of cloths. If the gripping system makes contact at the edge of the stack, which is uneven, for example due to a seam of the non-rigid material parts, the pressure exerted by the press-down unit guarantees that the gripping means of the gripping system can engage with the material of the non-rigid material part, for example engage into the fabric of a napkin or engage on the material of the non-rigid material part or grasp the material of the non-rigid material part. In addition, the press-down unit evens out any possible unevenness of the non-rigid material part. In particular, the press-down unit according to the invention allows rapid and secure accommodation of the non-rigid material parts, thereby making it possible to transport high volumes within a short period of time.

Particularly preferably, the press-down unit has a sensor or a sensor device, for example a photo-eye device, an inductive device, a mechanical device, etc., for recognizing a height of a stack of non-rigid material parts on the conveyor belt. In this way, targeted recognition of the height of a stack of non-rigid material parts is made possible in a simple manner. In particular, incorrect operation of the folding apparatus is reliably avoided.

In one embodiment, the transport unit has a sensor unit for recognition of non-rigid material parts on the conveyor belt. In this connection, the sensor unit has a simple structure and merely has one sensor that interacts with the reflective surface of the conveyor belt. Despite the simple structure, reliable recognition of non-rigid material parts by the sensor unit is possible.

In another embodiment, the folding unit works together with the tool system of the transport unit and/or the tool system of the conveying unit. Preferably, the tool system of the supply unit can cooperate with the tool system of the transport unit, and take non-folded non-rigid material parts over individually from the conveying unit, in order to then roll up, fold and/or iron these in the folding unit.

Furthermore, a folding apparatus for folding of non-rigid material parts, particularly a napkin folding apparatus, is proposed, which has a storage unit having stackable boxes to be filled with folded non-rigid material parts from the folding unit. In this way, storage of large amounts of folded non-rigid material parts in the storage unit is possible during operation. Emptying of the storage unit is only required at great intervals, thereby resulting in a significant time savings in connection with folding of non-rigid material parts. Operation of the napkin folding apparatus is therefore possible even over a longer period of time, without manual intervention. Thus, for example, a filled box or stack of boxes can be removed from the storage unit without interrupting or disturbing ongoing operation. Likewise, issuance of individual folded non-rigid material parts is also possible.

In one embodiment of the invention, the storage unit comprises a storage station that is provided for keeping unfilled boxes on hand and accommodating filled boxes, a filling station for a box currently to be filled, an intermediate station that is provided for keeping unfilled boxes on hand, and a conveying device that is provided for transporting unfilled boxes out of the storage station into the filling station and/or the intermediate station and for transporting filled boxes to the storage station. A significant advantage of the present invention lies in the compact, practical arrangement of the various components of the storage unit, which can logistically process large numbers of folded non-rigid material parts with set items, thereby resulting in great time savings.

In another embodiment, the boxes are kept on hand stacked in the storage station. Furthermore, it is proposed that at least one box and/or at least one stack of boxes is/are accommodated on at least one movable base. Preferably, these are boxes that are automatically filled with folded non-rigid material parts during operation of the folding apparatus, and stacked on top of one another. Replacement of the filled movable stack of boxes takes place manually, at greater intervals, and an empty stack of boxes is always kept on hand in the storage station.

Preferably, charging of the storage station with boxes and/or stacks of boxes and/or removal of the boxes and/or stacks of boxes from the storage station takes place manually, automatically and/or semi-automatically. Filling of individual boxes of a stack of boxes takes place first, which are then removed without interrupting or disturbing ongoing operation. During manual, automatic and/or semi-automatic removal, filling of the second stack of boxes already takes place, thereby saving time and costs.

In an embodiment of the folding apparatus according to the invention, the conveying device has a gripping system with grippers that work together with gripper accommodations of the boxes. Secure conveying of the empty and filled boxes by means of the interaction of the gripping system that has grippers with the gripper accommodations of the boxes, in order to allow undisturbed provisioning of empty boxes and removal of the full boxes, is particularly advantageous. Preferably, a box on the filling station can always be positioned at the same height, so that the gripping system can always remove the full box at the same location or at least at a defined location, and set down a new, empty box, thereby reducing the risk of disruption of operation.

In another embodiment of the folding apparatus according to the invention, the conveying device is attached on a frame construction of the folding apparatus so as to move along at least two axes. In this way, the conveying device can be moved in a defined manner, in the storage unit, downward to the uppermost empty box of one of the two stacks of boxes, for gripping and removing the box from the stack of boxes, or upward to the filling station, in order to place the empty box down on the filling station. Likewise, the conveying device, which has a simple and cost-advantageous structure, is suitable for picking the filled box up from the filling station and placing it down on one of the two stacks of boxes or on one of the two movable bases or in the intermediate station.

A preferred embodiment of the folding apparatus according to the invention provides for a checking unit that is provided for recognition of flatware. The checking unit preferably recognizes the position and the type of flatware, the position of each non-rigid material part, and additionally defined problems, such as, for example, damage and/or dirt. In this way, the risk of disruptions and interruptions during operation due to incorrectly positioned set items and non-rigid material parts is reduced, and this in turn saves time and money.

Furthermore, a banding unit is proposed, which is provided for banding of folded non-rigid material parts. In advantageous manner, the non-rigid material parts that have been outfitted with set items, folded, and banded cannot unfold or open on their own, and are therefore very well suitable, for example in the case of a napkin folding machine, for transport and for serving by the gastronomy personnel. Alternatively or in addition, it is possible, using the banding unit, to perform ring placement, labeling, loop placement and/or cording of the folded non-rigid material parts. Likewise, it is possible that imprinting of the band, the label, or the like can be performed on site, so that the user can change an imprint daily, for example, or as needed.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows in a perspective representation, a rear view of a napkin folding apparatus according to the invention, having a supply unit, a transport unit, a provisioning unit, a folding unit, a storage unit, and a housing that surrounds the transport unit, the provisioning unit, the folding unit, and the storage unit, at least in part;

FIG. 2 shows the napkin folding apparatus according to the invention from FIG. 1, without a housing;

FIG. 3 shows in a perspective representation, a front view of the napkin folding apparatus according to the invention, with a housing;

FIG. 4 shows a detail of the napkin folding apparatus in the region of the folding unit, with the provisioning unit, which has a deposit unit for flatware;

FIG. 5 shows in a perspective representation, a side view of the napkin folding apparatus according to the invention, without a housing;

FIG. 6 shows a detail of the napkin folding apparatus in the region of the folding unit, with the deposit unit of the provisioning unit, the transport unit, and a conveying unit;

FIG. 7 shows a top view of the napkin folding apparatus according to the invention;

FIG. 8 shows in a perspective representation, the transport unit with a tool system that has a needle gripping system, and/or a finger gripping system and/or a jaw gripping system and/or other gripping systems;

FIG. 9a shows a detail view of the tool system of the transport unit from FIG. 8 in FIG. 9a;

FIG. 9b shows a perspective representation of an alternative embodiment of a transport unit, having a sensor unit for recognition of napkins and a gripping system that is connected with a frame construction of the transport unit by way of a press-down unit;

FIG. 9c shows a top view of the transport unit from FIG. 9b with the press-down unit, which has a sensor or a sensor device, for example a photo-eye device, an inductive device, a mechanical device, etc., for recognition of a napkin stack height;

FIG. 10 shows in a perspective representation, the conveying unit having a changing system for changing of tool systems kept on hand in a magazine;

FIG. 11 shows in a perspective representation, a changing system of the conveying unit, having an adapter on the handling system side and an adapter on the tool side;

FIG. 12 shows in a perspective representation, a tool system of the conveying unit structured as a paddle;

FIG. 13 shows in a perspective representation, a tool system of the conveying unit, which is structured as a flatware gripping tool having a magnet unit and a centering device;

FIG. 14 shows in a perspective representation, a tool system of the conveying unit structured as a slit pipe;

FIG. 15 shows a winding system that is structured as a tool system of a handling system, for example of a robot;

FIG. 16 shows a winding system that has a separate drive;

FIG. 17 shows in a perspective representation, a side view of a banding unit for banding of rolled-up and/or folded napkins;

FIG. 18 shows in a perspective representation, a detail of the banding unit in the region of a deposit device for a napkin to be banded;

FIG. 19 shows in a perspective representation, a top view of a rolled-up napkin with a band;

FIGS. 20a to 20c shows a winding process of a napkin by means of the tool system structured as a slit pipe;

FIG. 21 shows in a perspective representation, a side view of a tool system structured as a roller unit;

FIGS. 22a to 22c show a winding process of a napkin by means of the tool system structured as a roller unit;

FIGS. 23a to 23g show a winding process of a napkin by means of a tool system structured as a streamer;

FIGS. 24a to 24c show a winding process of a napkin using a tool system structured as a gripping unit; and

FIGS. 25a to 25j show a representation of the movement sequence of the boxes in the storage unit, in a perspective representation.

### DETAILED DESCRIPTION OF THE PREFERRED EMBODIMENT

The invention is shown as an example, using a napkin folding apparatus, with napkins as non-rigid material parts and flatware pieces as set items.

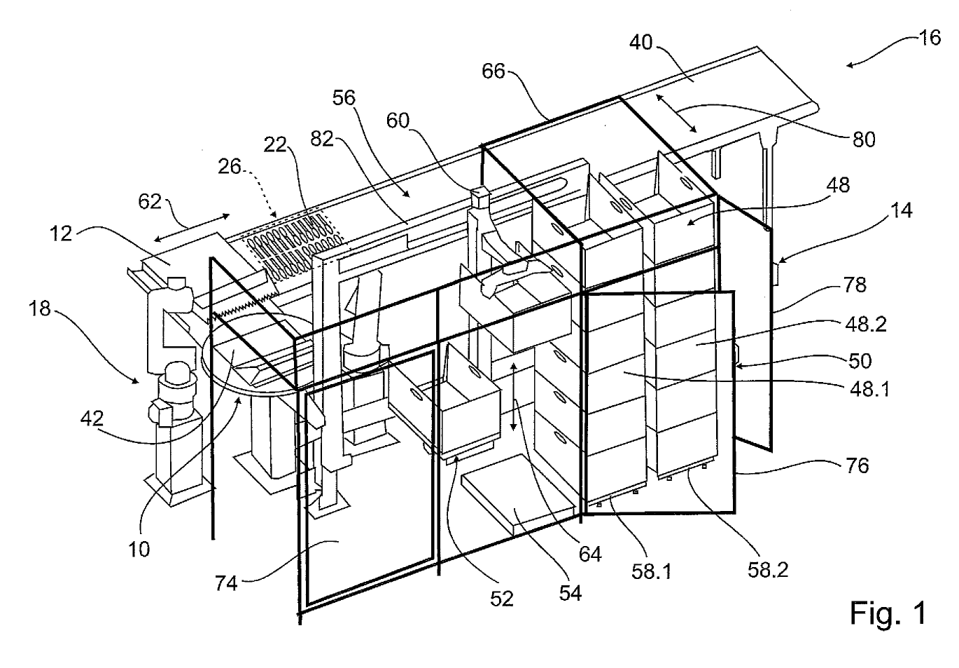

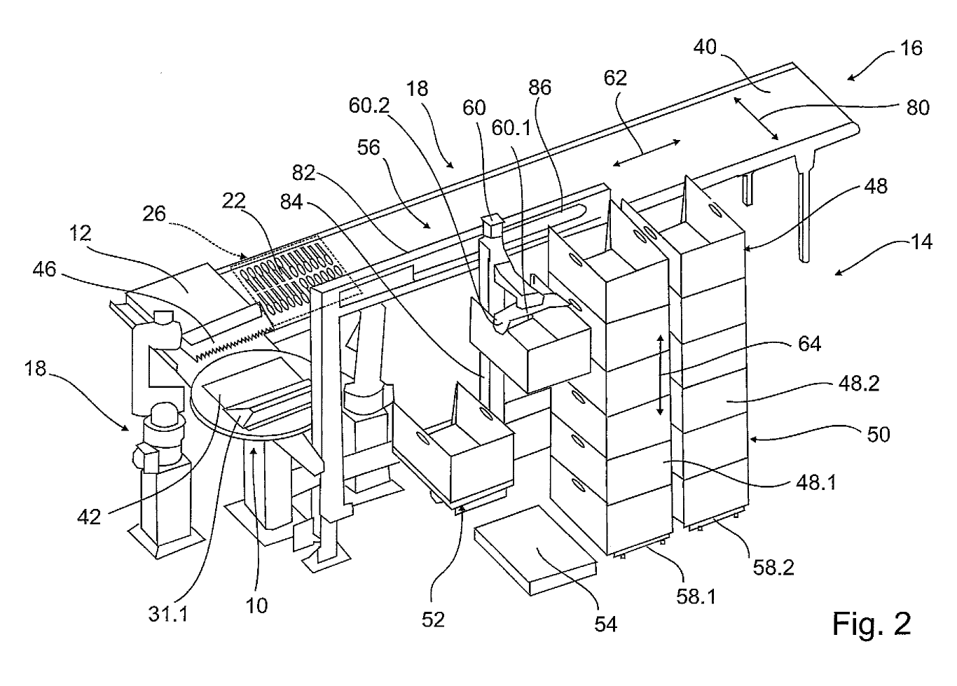

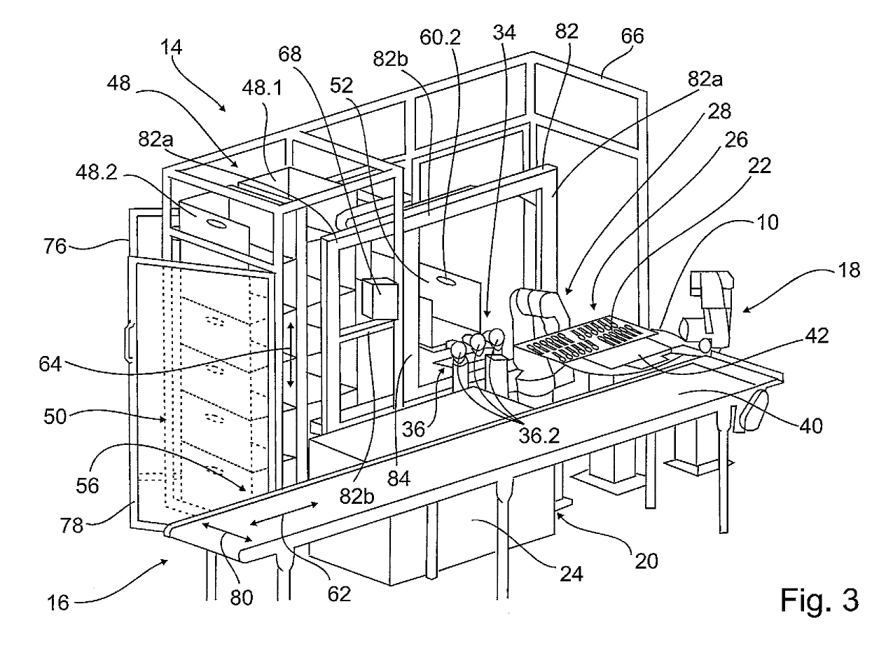

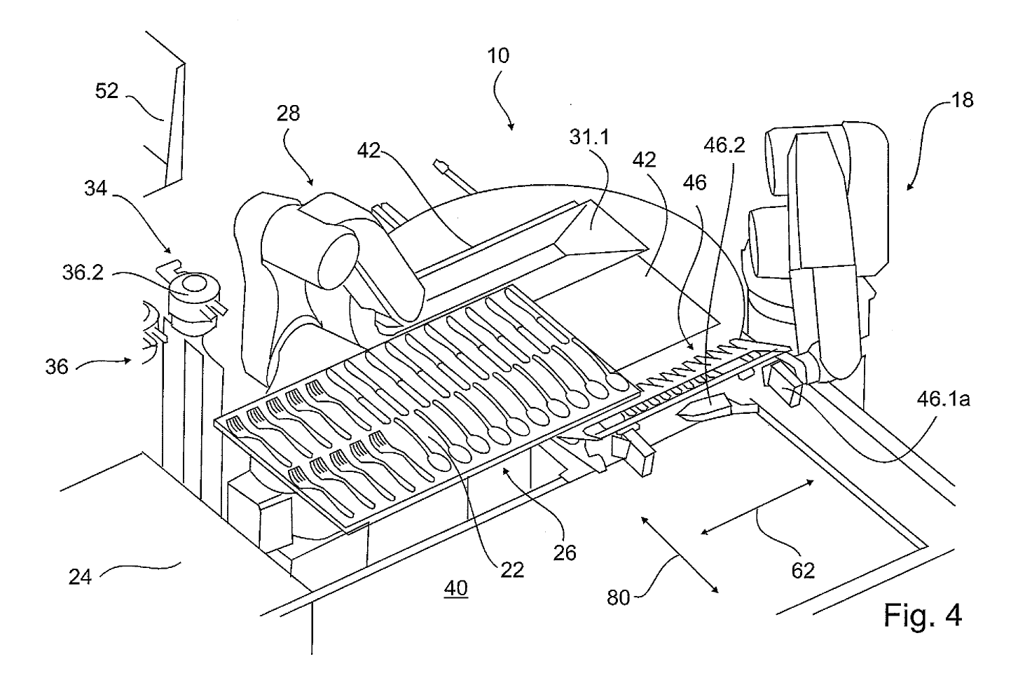

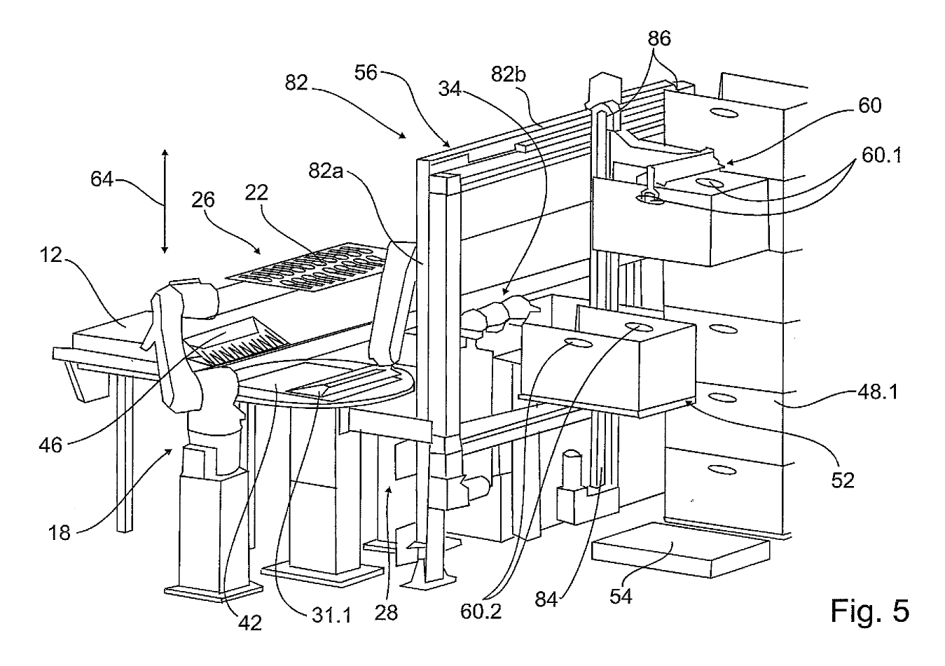

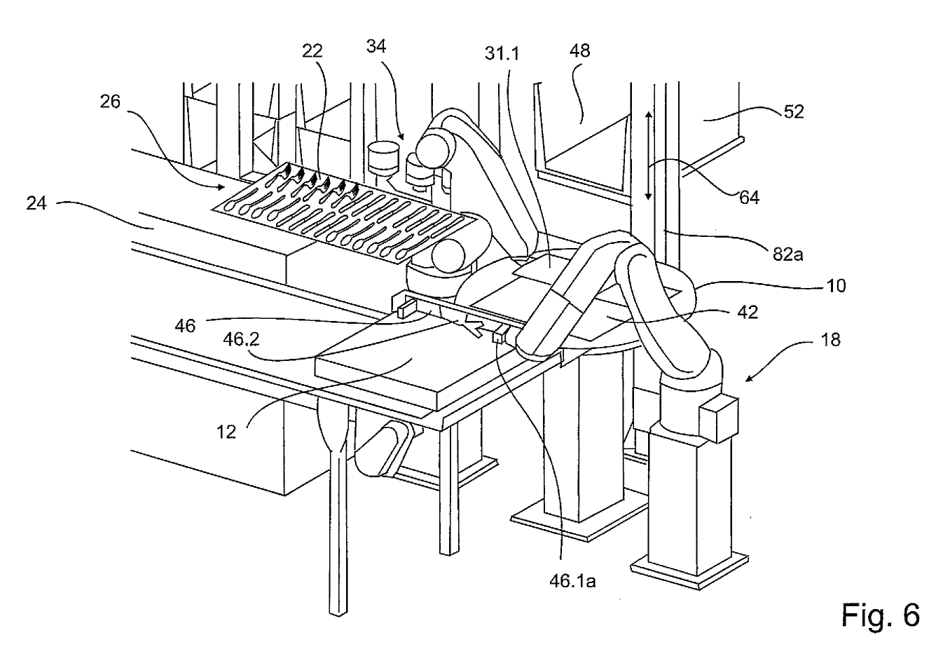

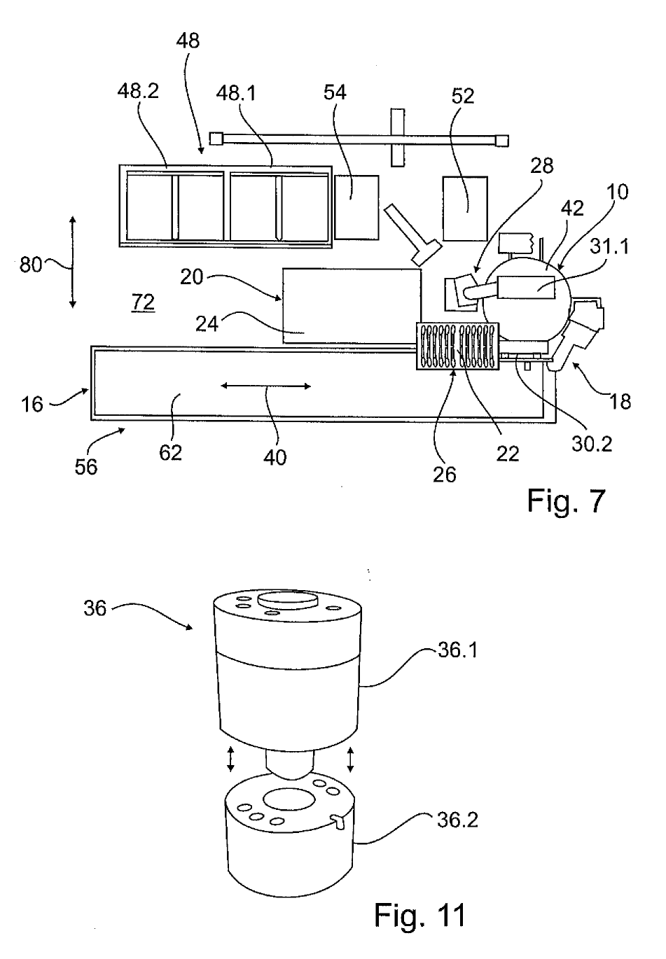

FIG. 1 to 7 show a folding apparatus according to the invention, having a folding unit 10 that is provided for folding of individual napkins 12, and a storage unit 14 that is provided for accommodating the folded napkins 12 from the folding unit 10. Likewise, the folding apparatus comprises a supply unit 16 that is provided for keeping on hand non-folded napkins 12, and a transport unit 18 that is provided for feeding the non-folded napkins 12 from the supply unit 16 to the folding unit 10.

The four units 10, 14, 16 and 18 of the folding apparatus, as indicated above, stand in an active connection with one another or are functionally connected with one another, i.e. the supply unit 16 is coupled with the transport unit 18, which in turn stands in connection with the folding unit 10, which in turn is coupled with the storage unit 14. In other words, each individual napkin 12 passes through the four units 10, 14, 16, and 18 of the folding apparatus.

In the present exemplary embodiment, the supply unit 16 and the storage unit 14 are disposed one behind the other, forming an intermediate space 72, and accommodate the transport unit 18 and the folding unit 10 between them, which are thereby disposed to lie essentially next to one another. However, other arrangements of the units 10, 14, 16, and 18 that appear practical to a person skilled in the art are also possible.

The units 10, 14, and 18 are preferably accommodated in a common housing 66, preferably having a frame structure, which has at least one door 74, 76, 78 for accessibility to the units 10, 14, and 18. Alternatively to this, the complete folding apparatus can also be accommodated in a housing. In the present exemplary embodiment, the housing 66 is configured in block shape. Preferably, this is a housing 66 made of a metallic material, whereby other materials that appear practical to a person skilled in the art are also possible for the housing 66. Preferably, the doors 74, 76, 78 are produced from a transparent material.

In order to indicate a folding apparatus with which a significant improvement in the folding of napkins 12 is made possible, the folding apparatus has a provisioning unit 20 that is provided for keeping flatware 22 on hand for the folding unit 10. The provisioning unit 20 comprises a withdrawal unit 24 for storing unsorted flatware 22 and a deposit unit 26 for accommodating sorted flatware 22. In the present exemplary embodiment, the withdrawal unit 24 is a box for storing the unsorted flatware 22, and the deposit unit 26 is a tray, for example attached to the folding apparatus, for accommodating the sorted flatware 22. The deposit unit is disposed vertically above the supply unit, for example. The provisioning unit 20 is also disposed in the intermediate space 72 formed by the supply unit 16 and the storage unit 14.

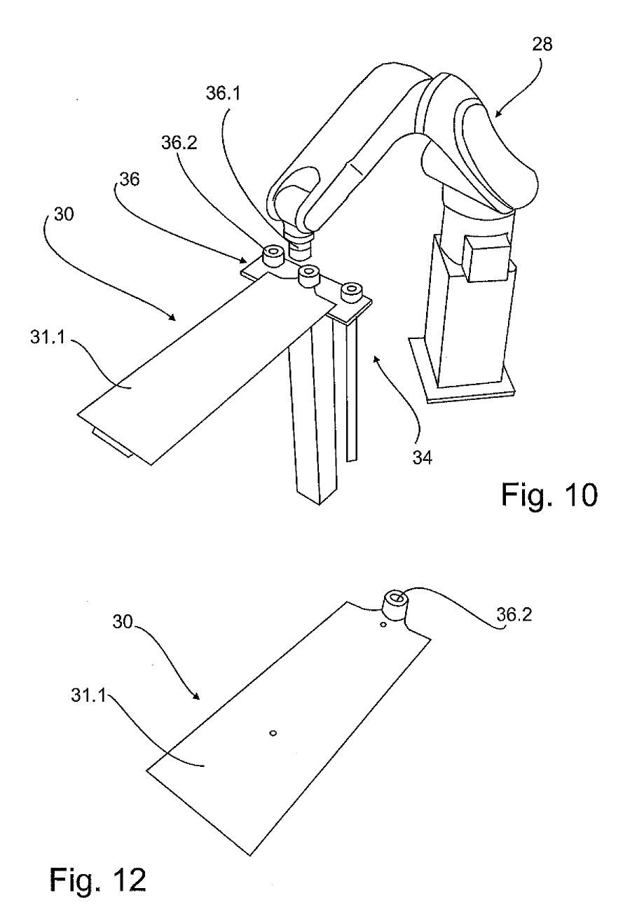

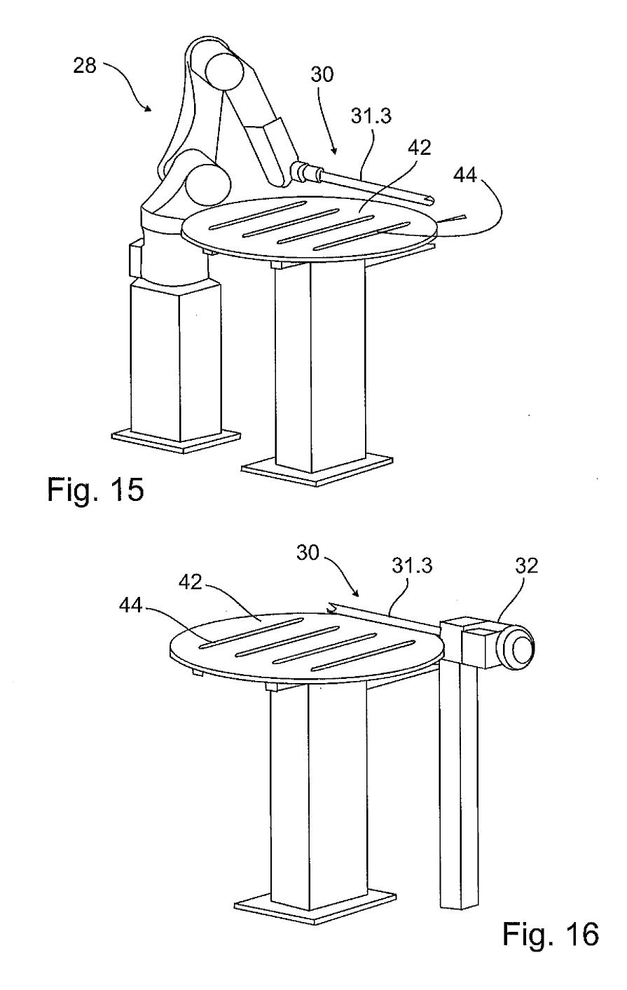

To convey the flatware 22 from the withdrawal unit 24 to the deposit unit 26 of the provisioning unit 20, a conveying unit 28 is provided. As is shown in FIG. 10 to 16, the conveying unit 28 has a gripping and/or winding system 30.1 for this purpose. In addition, the conveying unit 28 can also have a hold-down system 30.2 and/or a bracket system 30.3. In the present exemplary embodiment, the gripping and/or winding system 30.1 and/or the bracket system 30.2 and/or the hold-down system 30.3 is/are configured as a tool system 30 of a handling system, configured, as an example, as a robot, which is disposed between the withdrawal unit 24 of the provisioning unit 20 and the transport unit 18. In this connection, the winding system 30.1a can be structured, according to FIG. 15, as a tool system 30 of the exemplary robot, or can have a separate drive 32 according to FIG. 16.

In addition, the folding apparatus comprises a magazine 34, shown, for example, in FIG. 10, which is provided for provisioning tool systems 30 for the conveying unit 28. The magazine 34 is configured in such a manner that the tool systems 30 can be taken out in the direction of a vertical axis 64 of the folding apparatus. To replace tool systems 30 kept on hand in the magazine 34, the conveying unit 28 has a changing system 36 shown in detail in FIG. 11, which comprises an adapter 36.1 on the handling system side and an adapter 36.2 on the tool side.

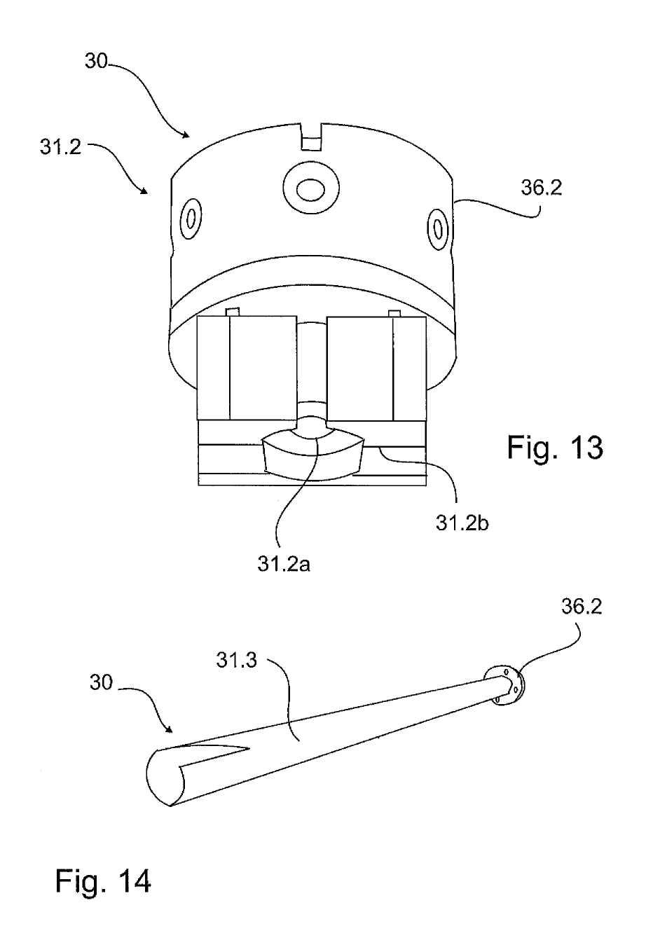

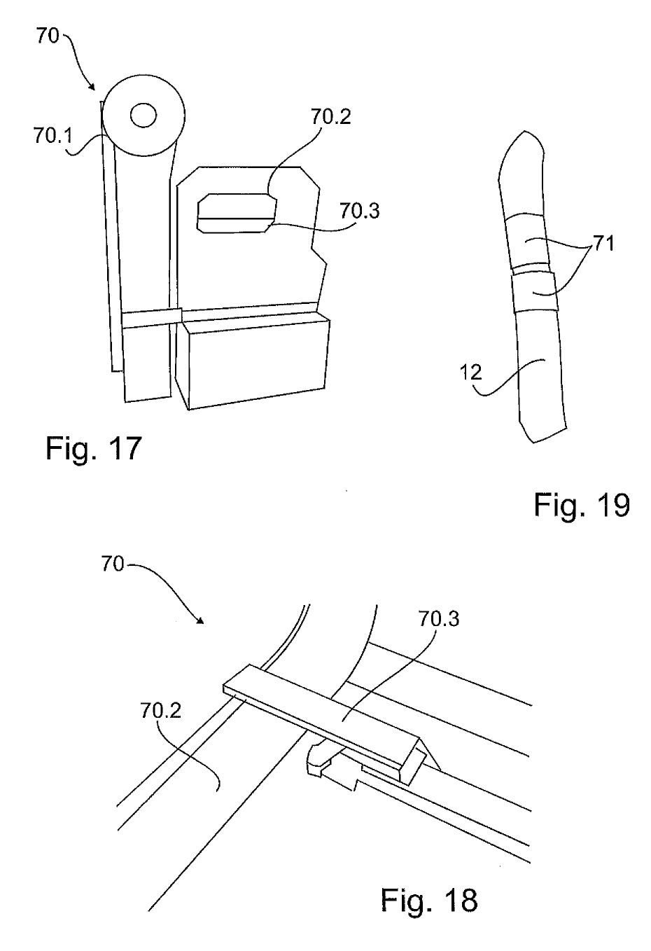

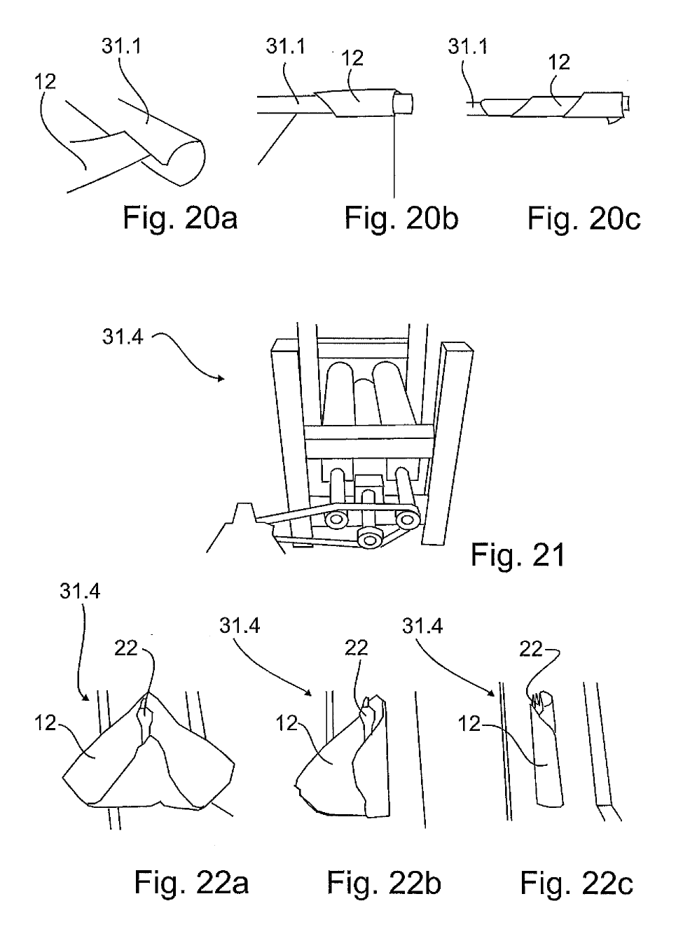

As explained in greater detail below, the conveying unit 28 works together, at the same time, with the folding unit 10 and the transport unit 18. The conveying unit 28 shown in greater detail in FIG. 10 to 16 is designed in such a manner that it can handle various tasks. In advantageous manner, the handling system of the conveying unit 28 can independently switch between multiple tool systems 30, depending on the task to be performed. FIG. 12 shows, in this regard, a tool system 30 of the conveying unit 28 structured as a paddle 31.1, which is provided for holding down the napkin 12 during folding, and for transporting the folded napkin 12 away or for laying the folded napkin 12 into a box located in the filling station 52 of the storage unit 14. FIG. 13 shows a tool system 30 of the conveying unit 28 configured as a flatware gripping tool 31.2, which has a magnet unit 31.2a for accommodating the flatware 22 and a centering device 31.2b for aligning the accommodated flatware 22. The flatware gripping tool 31.2 is provided to pick up the flatware from the conveyor belt of the supply unit 16, and to lay the flatware down onto a napkin 12 that has been prepared on the table of the folding unit 10. FIG. 14 shows a tool system 30 of the conveying unit 28 structured as a slit pipe 31.3 or as a pipe provided with a threading slit, for production of what is called a “candle napkin,” whereby this napkin can subsequently be laid, according to FIG. 17 to 19, into a banding unit 70, for placing a band around it, whereby FIG. 19 represents the rolled-up and banded napkin 12. FIGS. 20a to 20c show the rolling-up process in the production of what is called a “candle napkin,” using the tool system structured as a slit pipe 31.3.

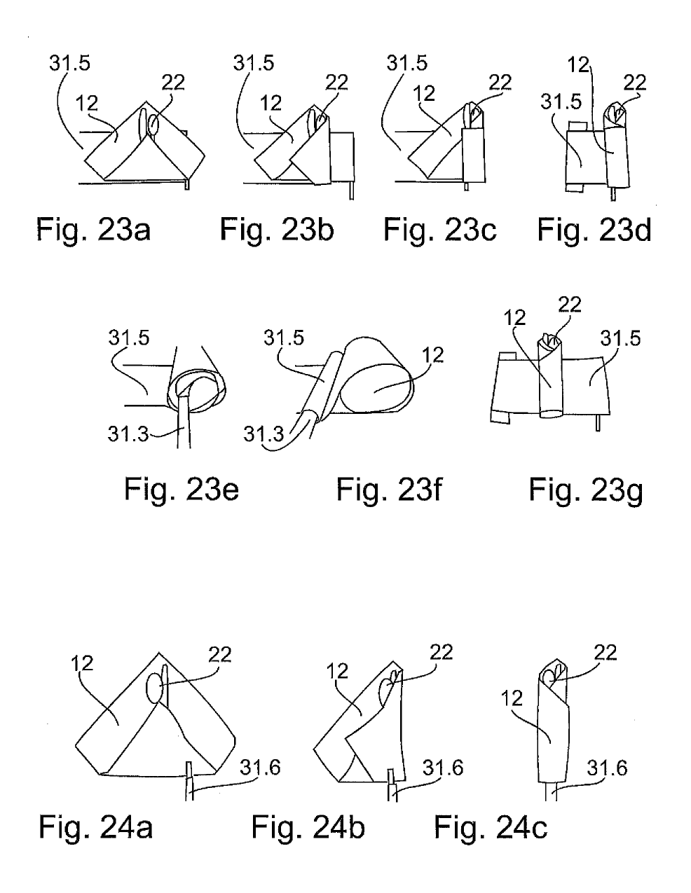

Preferably, according to FIG. 21, 22a to 22c, 23a to 23g, 24a to 24c, three principles are providing for rolling flatware 22 up into a napkin 12. In a first principle according to FIG. 21, 22a to 22c, a roller unit 31.4 is provided as a tool system for rolling flatware in, which unit can be structured as the tool system of the handling system, for example of a robot, or can be provided in a separate roll-up station. FIGS. 22a to 22c show the rolling-up process with the roller unit 31.4, in which, according to FIG. 22a, first the napkin 12 plus the flatware 22 placed in it is positioned on the roller unit 31.4. Subsequently, according to FIG. 22b, the right side of the napkin 12 is folded in, by turning the rollers of the roller unit 31.4. Further rotation of the rollers, according to FIG. 22c, brings about completion of the rolled-up napkin 12. In a second principle, a streamer 31.5 is provided as the tool system. FIGS. 23a to 23g show the rolling-up process with the streamer 31.5. In FIG. 23a, positioning of the napkin 12 outfitted with the flatware 22 takes place on the streamer 31.5. In FIG. 23b, the napkin 12 is shown with the right corner folded in. In FIG. 23c, the streamer 31.5 is folded in, and in FIG. 23d, the streamer 31.5 is completely rolled up, with the napkin 12 enclosing the flatware 22. FIG. 23e shows the streamer 31.5 rolled into the napkin 12, and FIG. 23f shows the streamer 31.5 rolled out of the napkin 12. In FIG. 23g, the completed napkin 12 is shown. In a third principle according to FIGS. 24a to 24c, a gripping unit 31.6 is provided as the tool system, with which first, the napkin 12 with the flatware 22 placed in it is gripped at a right side. Subsequently, according to FIG. 24b, the right corner of the napkin 12 and after that, according to FIG. 24c, the left corner of the napkin 12 is folded in, whereby FIG. 24c shows the completed napkin 12.

According to FIG. 1 to 7, the supply unit 16 provided for keeping non-folded napkins 12 on hand has a conveyor belt 40 guided in the direction of a longitudinal axis 62, along an advancement path, to be filled with non-folded napkins 12. The conveyor belt 40 can be outfitted not only with individual napkins 12 but also with stacks of napkins 12.

In the present embodiment, the folding unit 10 provided for folding of individual napkins 12 is configured as a table that is provided with a friction coating 42 and/or a counter-sinkable fixation unit 44 and/or a partial vacuum device, not shown here, and/or a separation apparatus, also not shown here, and/or a hold-down apparatus, also not shown here. Preferably, the friction coating 42 is also structured so that it can be counter-sunk in the table 10 or lowered into the table 10, so that the friction coating 42 can come into use as needed. The table 10 fixes the napkin 12 in place, at least in part, during the folding process, for example by means of the friction forces exerted by the friction coating and/or by means of light suction and/or hold-down forces. In addition, a separation apparatus (not shown here) is provided, which can separate the various plies of a folded napkin 12 or separate/loosen them from one another. The separation apparatus is preferably structured similar to a hold-down device. In this way, the table 10 serves not only for accommodating non-folded napkins 12, but also for accommodating and integrating fixation devices and separation apparatuses.

Particularly preferably, the table 10, which is preferably disposed in the region of one end of the supply unit 16, is structured so that it can rotate. The napkins 12 folded on the table 10 get into the storage unit 14 by way of the tool system 30 or gripping system 30.1 of the conveying unit 28 or an alternative conveying unit that appears practical to a person skilled in the art.

The transport unit 18 provided for feeding the non-folded napkins 12 from the supply unit 16 to the folding unit 10 is disposed next to the folding unit 10 or next to the table, and has a gripping and/or winding system 46.1 and/or a bracket system 46.2 and/or a hold-down system 46.3. The gripping and/or winding system 46.1 and/or the bracket system 46.2 and/or the hold-down system 46.3 is/are configured as a tool system 46 of a handling system configured as a robot, for example. The drive of the tool system 46 can take place hydraulically, mechanically, pneumatically, or electrically. In this connection, the gripping and/or winding system 46.1 is configured as a needle and/or Bernoulli-Venturi and/or Coanda and/or mechanical gripping system 46.1a and/or finger gripping system and/or jaw gripping system 46.1c. The gripping system 46.1 can have grippers that are present as single-finger, two-finger, or multi-finger grippers, in a rigid, rigid-articulated, or elastic embodiment. The grippers are preferably rigidly attached to an arm of a robot, for example, which allows both rotational movements and linear movements of the robot arm or of the grippers.

In the present embodiment, the folding unit 10 works together with the tool system 46 of the transport unit 18 and the tool system 30 of the conveying unit 28. In advantageous manner, the tool system 46 of the transport unit 18 works together with the tool system 30 of the conveying unit 28. Therefore the tool system 46 of the transport unit 18 functions as a supportive complement to the tool system 30 of the conveying unit 28.

The table or the folding unit 10 and/or the conveying unit 28 and/or the transport unit 18 is/are structured so as to rotate. Preferably, the table or the folding unit 10 and/or the conveying unit 28 and/or the transport unit 18 can thereby be freely positioned.

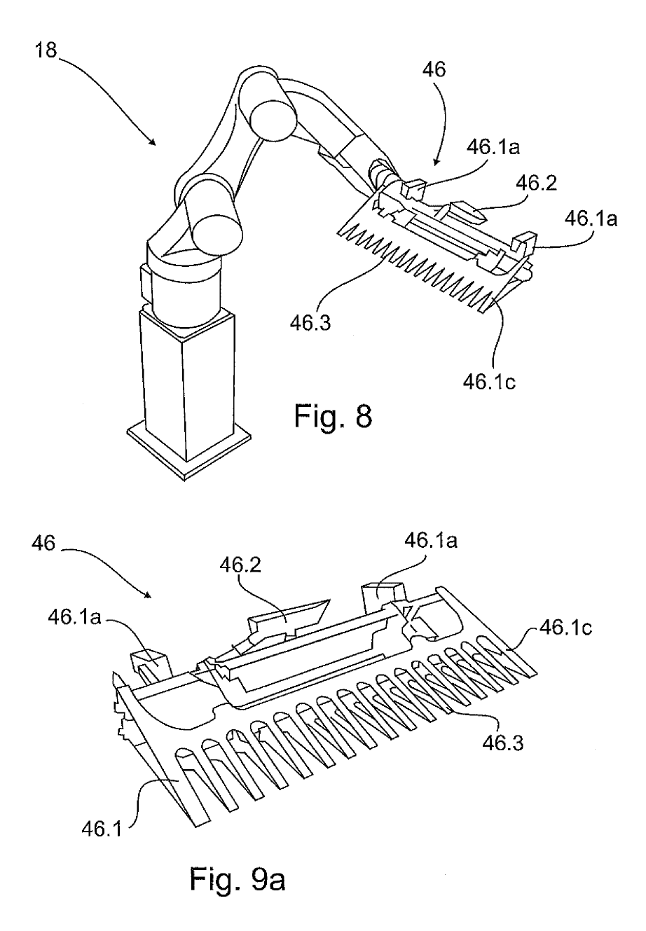

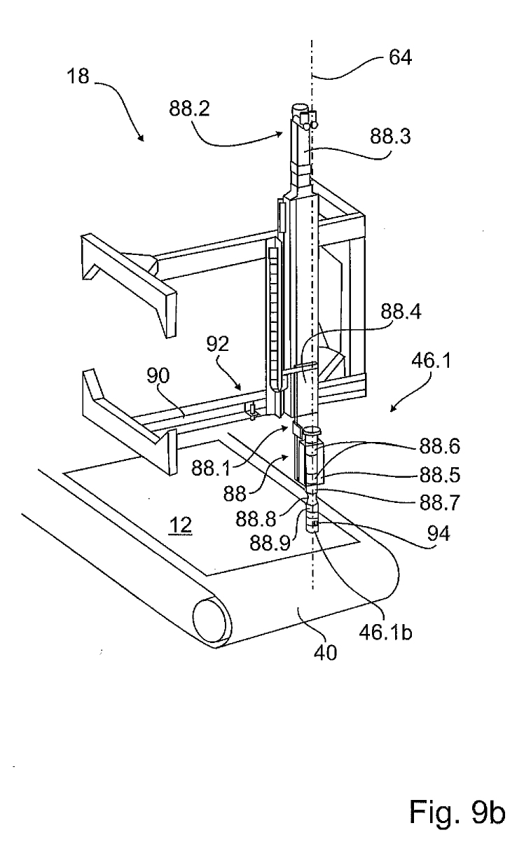

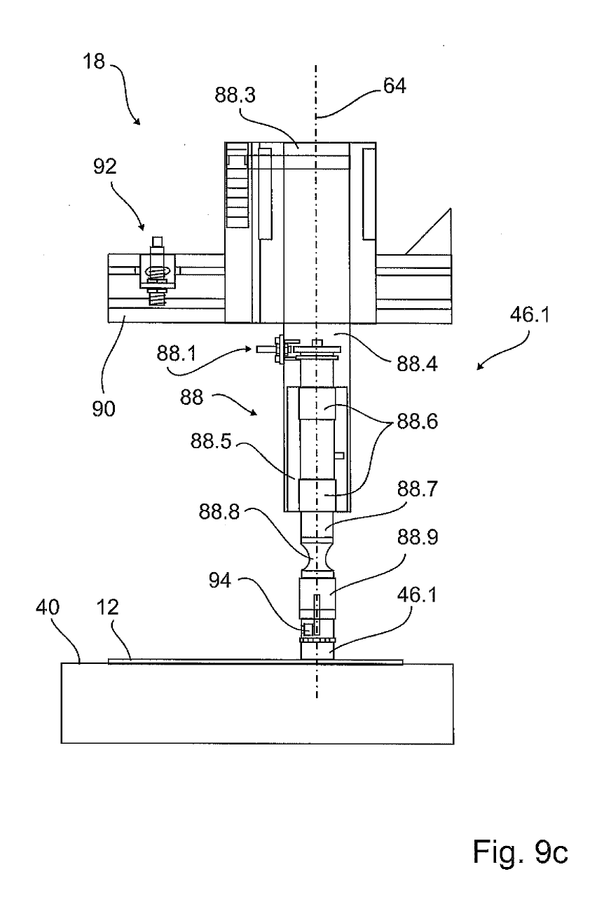

The transport unit 18 shown in greater detail in FIGS. 8 and 9a is designed in such a manner that it can handle different tasks. For this purpose, a gripping system 46.1a is provided, which can be a needle gripping system and/or a finger gripping system and/or a jaw gripping system. By way of the gripping system 46.1a, the transport unit 18 can separate the napkins 12, i.e. during operation of the folding apparatus, one napkin 12 is removed from the stack accommodated on the conveyor belt of the supply unit 16 by the transport unit 18, by way of the gripping system 46.1a, and transported to the table of the folding unit 10 and aligned on the table. Subsequently, the napkin 12 can be processed by the folding unit 11 and/or the tool system 46 of the transport unit 18 and/or the tool system 30 of the conveying unit 28. By way of the jaw gripping system 46.1c, the transport unit 18 can fold the napkins 12, at least in part, and reinforce or iron the fold of the napkins 12 by way of the bracket system 46.2.

According to FIGS. 9b and 9c, the transport unit 18 has a sensor unit 92 for recognition of napkins 12 or of a stack of napkins 12 on the conveyor belt 40. The sensor unit recognizes whether or not a napkin 12 or a stack of napkins 12 is lying on the conveyor belt 40.

In FIGS. 9b and 9c, an alternative embodiment of a gripping and/or winding system 46.1 of the transport unit 18, with a gripping system 46.1b that can be a needle and/or Bernoulli-Venturi and/or Coanda and/or mechanical gripping system, is shown. The gripping system 46.1b can also be used, independent of the folding apparatus described here, in other systems in which non-rigid material parts are separated, such as seat covers, for example for car seats, armchairs, chairs, or O-rings made of rubber or plastic. In particular, using the gripping system 46.1b, it is possible to undertake removal of the non-rigid material parts from a stack of the non-rigid material parts.

The gripping system 46.1b is connected, by way of a press-down unit 88, with the handling system, for example a robot, or the frame construction 90 of the folding apparatus. The press-down unit 88 comprises a linear axis unit 88.3 that can be moved, by means of a drive 88.2 according to FIG. 9b, in the direction of a vertical axis 64, an adapter unit 88.4 that can be attached to the linear axis unit 88.3, and a guide unit 88.5 that is fixed in place on the adapter unit 88.4, in which a shaft 88.7 is guided in slide bearings 88.6. The shaft 88.7 is connected with the gripping system 46.1b for accommodating a napkin 12 that lies on the conveyor belt 40, by way of an equalization element 88.8 and an adapter element 88.9. The gripping unit 46.1b stands in an active connection with a connection unit 94 for connection of a pneumatic unit, not shown here. The equalization element 88.8 can particularly be an elastic element, for example a spring or a rubber element or the like.

Alternatively, the press-down unit 88 can be connected to a handling system, for example a robot or the like. However, other connections that appear practical to a person skilled in the art are possible for the press-down unit 88, the tool system 46 and/or the connection unit 94.

In addition, the press-down unit 88 comprises a sensor device, for example a sensor or a sensor device 88.1, for example a photo-eye device, an inductive device, a mechanical device, etc., for recognition of a height of a napkin 12 and/or of a stack of napkins 12 on the conveyor belt 40. The sensor or the sensor device 88.1 for recognition of the stack height is fixed in place, in a fixed location, on the adapter unit 88.4 of the press-down unit 88.

The sensor 92 now recognizes the stack of napkins 12 on the conveyor belt 40. However, the height of the stack is not known at first. Then, the linear axis unit 88.3, with the adapter unit 88.4 and the guide unit 88.5 that is attached to the adapter unit 88.4 and accommodates a shaft 88.7 having an inherent weight, slowly moves down until the gripper unit 46.1b that is connected with the shaft 88.7 touches the uppermost napkin 12 of the stack. As a result, the downward movement of the shaft 88.7 is stopped. However, because the linear axis unit 88.3 with the sensor or the sensor device 88.1 continues to move downward, the shaft 88.7 comes to a stop because of its mounting in the slide bearings 88.6 of the guide unit 88.5, until, at some time, it triggers a detection element of the sensor that moves along with the linear axis unit 88.3 or of the sensor device 88.1 that moves along with the linear axis unit 88.3, thereby making the height of the napkin stack known. The second and each further napkin 12 can afterwards be moved to in fast mode; only the last 2 to 3 mm of approach path are approached slowly again.

When the gripper unit 46.1b makes contact, the shaft 88.7 delivers the mass for exerting a defined pressure on the napkin stack 12. If the gripper unit 46.1b now makes contact at the edge of the stack, which is generally uneven due to the hem of the napkins 12, the equalization element 88.8 is compressed and the gripping means of the gripping unit 46.1b can engage into the fabric of the napkin 12 in a defined manner. In addition, the equalization element 88.8 evens out possible uneven regions of the napkin 12.

By means of the sensor unit 92, it is recognized whether a new napkin stack whose height must be measured is required. Likewise, opening of the door 74 between the supply unit 16 that serves to keep non-folded napkins 12 on hand and the transport unit 18 is recognized, so that a napkin stack that might have been introduced manually is also noticed, whose height must then also be newly measured. Incorrect operation of the transport unit 18 can thereby be reliably prevented.

In the present exemplary embodiment, the storage unit 14 provided for accommodation of the folded napkins 12 from the folding unit 10 has stackable boxes 48 to be filled with folded napkins 12. The boxes 48 are structured to be open to one side and to the top, and have accommodations 60.2 for grippers 60.1 of a gripping system 60 on the two sides that lie opposite one another.

The storage unit 14 comprises a storage station 50 that is provided to keep unfilled boxes 48 on hand and to accommodate filled boxes 48, a filling station 52 for a box 48 to be currently filled, an intermediate station 54 that is provided for keeping unfilled boxes 48 on hand, and a conveying device 56 that is provided for transporting unfilled boxes 48 from the storage station 50 to the filling station 52 and/or the intermediate station 54 and for transporting filled boxes 48 to the storage station 50. The boxes 48 are preferably kept on hand stacked in the storage station 50; in this connection, at least one box 48 and/or at least one stack of boxes 48.1, 48.2 is/are accommodated on at least one movable base 58.1, 58.2. Charging of the storage station 50 with boxes 48 and/or stacks of boxes 48.1, 48.2 and/or removal of the boxes 48 and/or stacks of boxes 48.1, 48.2 from the storage station 50 takes place manually, automatically and/or semi-automatically.

The conveying device 56 of the storage unit 14 has a gripping system 60 having grippers 60.1 that work together with the gripper accommodations 60.2 of the boxes 48. The conveying device 56 is attached to a frame construction 82 of the folding apparatus so that it can be moved along at least two axes 62, 64. For this purpose, the frame construction 82 is composed of two crossbars 82a that run in the direction of a vertical axis 64 and lie opposite one another, and guide rails 82b that run in the direction of a longitudinal axis 62 and lie opposite one another. The conveying device 56 comprises a column 84 that runs in the direction of a vertical axis 64 and has the gripping system 60 with grippers 60.1, which column is mounted in the guide rails 82b so as to be displaceable in the direction of the longitudinal axis 62. The column 84 is structured in such a manner that the gripping system 60 with the grippers 60.1 is mounted to be displaceable in the direction of the vertical axis 64. In the present exemplary embodiment, a drive 86 that is preferably structured as a belt drive and, in this connection, preferably as a toothed belt drive is provided. A drive, not shown here in any detail, is provided for moving the column 84 in the guide rails 82b of the frame construction 82, and the drive 86 structured as a belt drive is provided for moving the gripping system 60 along the column 84 of the conveying device 56 that runs in the direction of the vertical axis 64. The gripping system 60 is attached to the belt of the belt drive 86.

The filling station 52, in which the boxes 48 are preferably filled as a function of amount, is disposed or attached in the folding apparatus essentially at the height of the folding unit 10. Preferably, the filling station 52 is configured as a deposit surface for accommodating a box 48.

Preferably, the stacks of boxes 48.1, 48.2 are mounted on the movable bases 58.1, 58.2 and can be moved out or pulled out of the storage station 50 of the storage unit 14 or out of the housing 66 of the folding apparatus, preferably completely, after the doors 76, 78 of the housing 66 have been opened, in the direction of a transverse axis 80 and/or a longitudinal axis 62. This serves for removing the filled boxes 48 and for charging the storage unit 14 with empty boxes 48.

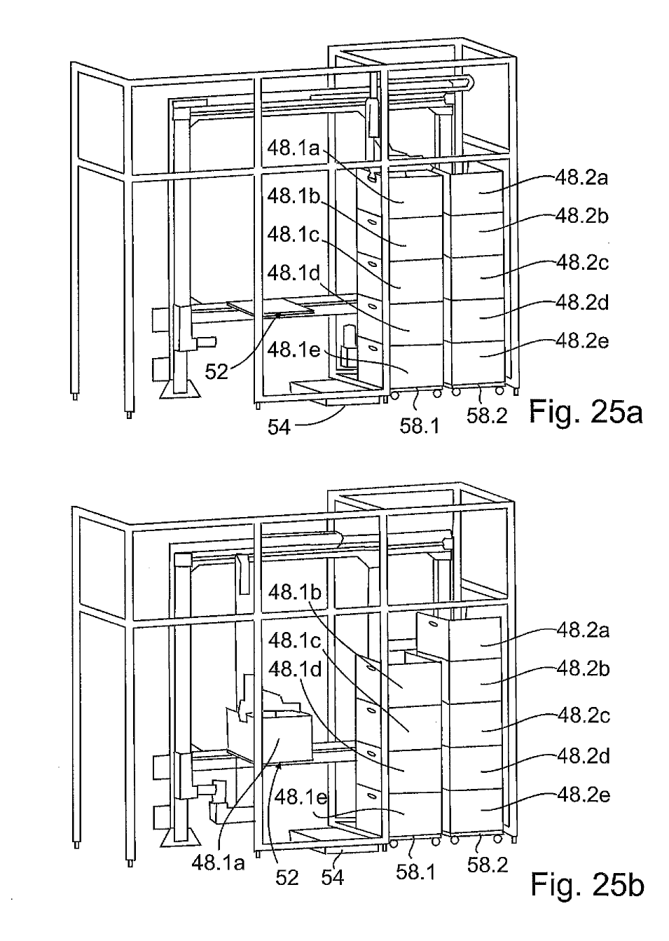

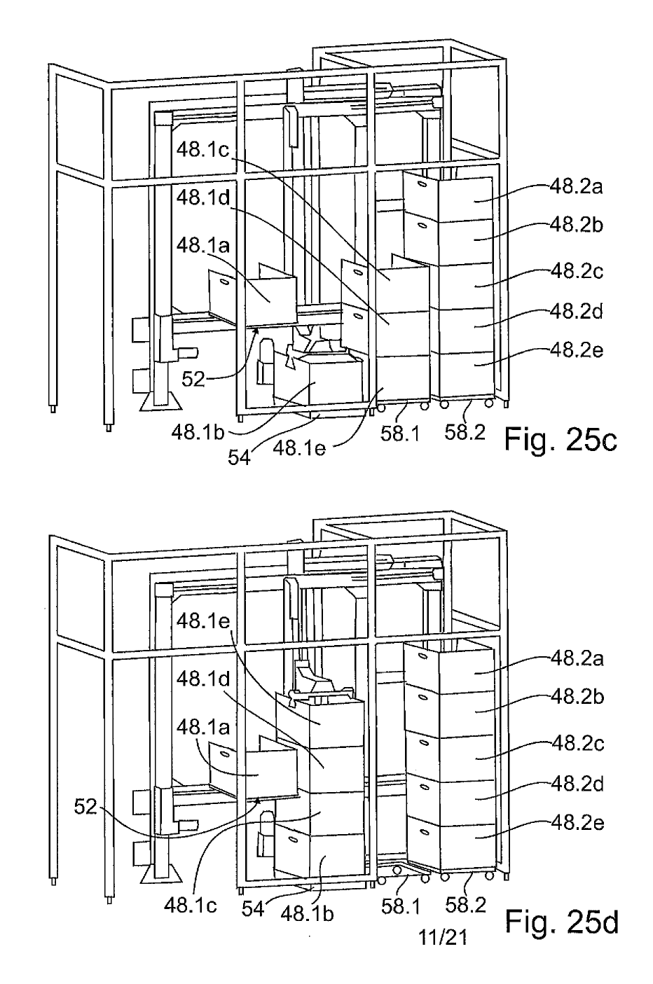

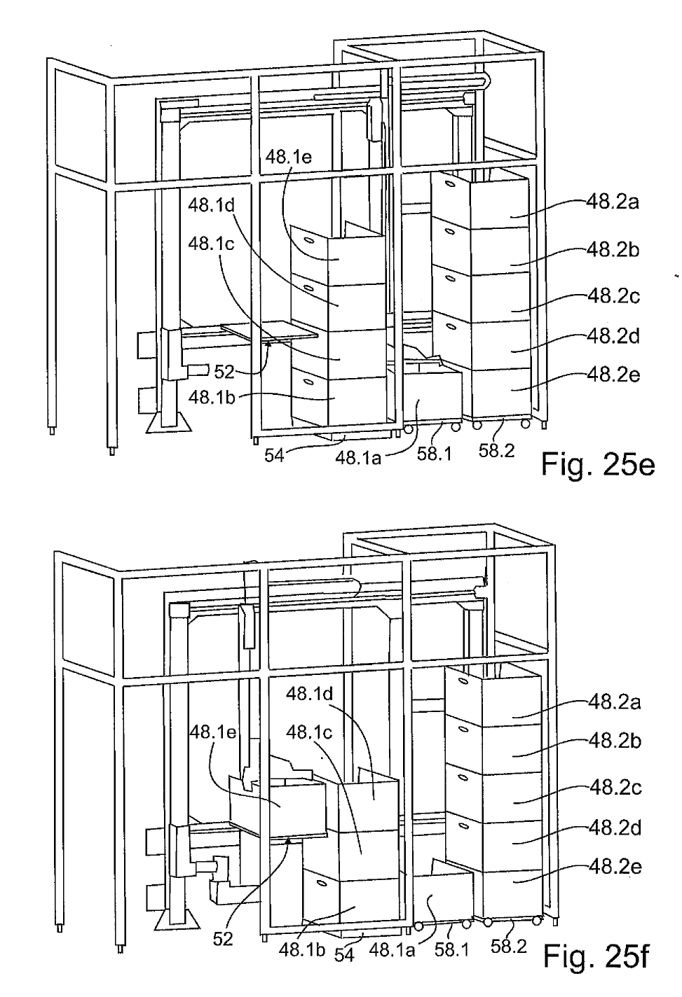

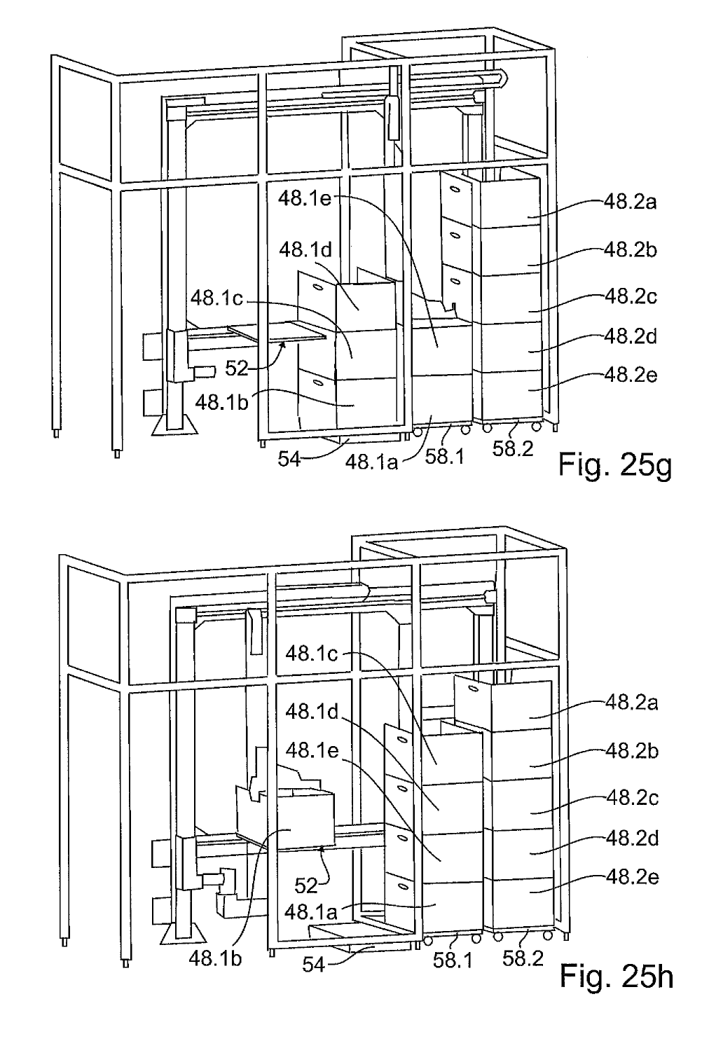

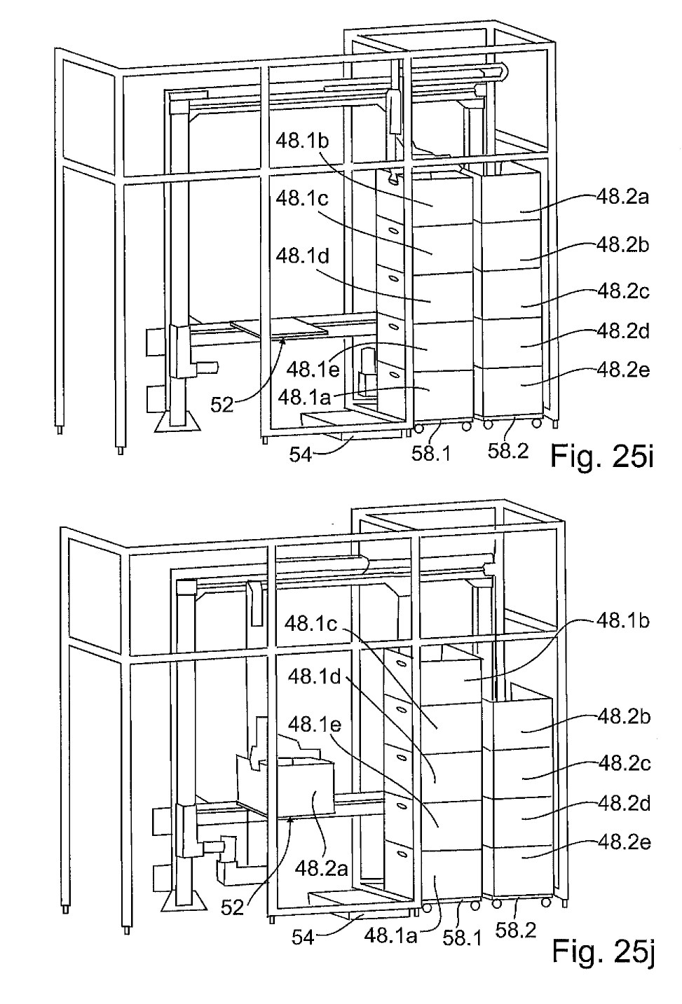

To move the boxes 48, the conveying device 56 is provided with the gripping system 60 that has the grippers 60.1. FIGS. 25a to 25j show a representation of the movement sequence of the boxes 48 in the storage unit 14. FIG. 25a shows the initial state of the empty boxes 48 in the storage station 50 of the storage unit, whereby a first stack of boxes 48.1, preferably having five boxes 48.1a to 48.1e, and a second stack of boxes 48.2, also preferably having five boxes 48.2a to 48.2e, are situated in the storage station 50. In FIG. 25b, the uppermost, empty box 48.1a is transported to the filling station 52 by the conveying device 56. During filling of this box 48.1a with folded napkins 12, the conveying device 56, according to FIGS. 25c and 25d, transports the other four empty boxes 48.1b to 48.1e of the first stack of boxes 48.1 to the intermediate station 54 of the storage unit 14, thereby causing the movable base 58.1 of the first stack of boxes 48.1 to now be situated in the storage station 50, without being loaded. After complete filling of the first box 48.1a of the first stack of boxes 48.1, the conveying device 56, according to FIG. 25e, now transports this box to the empty movable base 58.1 of the first stack of boxes 48.1 in the intermediate station 50. Subsequently, the conveying device 56, according to FIG. 25f, transports the uppermost box 48.1e of the first stack of boxes 48.1 to the filling station 52. After complete filling of this box 48.1e of the first stack of boxes 48.1, the conveying device 56, according to FIG. 25g, now transports this box onto the first box 48.1a in the storage station. This procedure is now continued until all the filled boxes 48.1a to 48.1e of the first stack of boxes 48.1, according to FIGS. 25h and 25i, are situated stacked on the movable base 58.1 in the storage station 50. Moving of the boxes 48.2a to 48.2e of the second stack of boxes 48.2 is carried out in analogous manner, whereby according to FIG. 25j, first the uppermost, empty box 48.2a of the second stack of boxes 48.2 is transported to the filling station 52 by the conveying device 56.

Preferably, the folding apparatus has a checking unit 68 that is provided for recognition of flatware 22. The checking unit 68 preferably monitors the provisioning unit 20 and, in this connection, particularly the withdrawal unit 24 and/or the deposit unit 26. The checking unit 68 is preferably a camera having an image recognition system, whose signals are provided for turning on the conveying unit 28, so that the conveying unit 28 not only removes the correct flatware 22 from the withdrawal unit 24 of the provisioning unit 20, but also feeds the correct flatware 22 to the folding unit 10 and/or the deposit unit 26 of the provisioning unit 20. Alternatively to a camera, a scanner, or, in the simplest case, one or more optical sensors can also be used. In the present exemplary embodiment, the checking unit 68 is supposed to recognize, first of all, the type and the position of the flatware 22, and, aside from this, additionally defined problems, such as, for example, damage, dirt, etc. In addition, the checking unit 68 preferably triggers an acoustical and/or optical alarm or a stop of the folding apparatus, if a problem, for example in the form of missing, dirty, or damaged flatware parts, is discovered. Incorrect folds can be recognized and corrected, if necessary.

In addition, the folding apparatus has the banding unit 70 shown in FIGS. 17 and 18, which is provided, according to FIG. 19, for banding of napkins 12 that have been folded and/or outfitted with flatware 22. The banding unit 70 has an unwinding device 70.1 for the banding material 71, an introduction frame 70.2 for the banding material 71, and a deposit device 70.3 for the napkin 12. Preferably, the banding unit serves for banding flatware sets and/or “candle napkins.” Preferably, paper and/or film and/or mixed forms is/are provided as banding material 71. For banding, first a non-banded but rolled-up napkin 12 is laid into the banding unit 70 by a handling system, for example a robot. The band 71 is placed around the napkin 12. Afterward, the band 71 is sealed. Subsequently, the banded set is removed from the banding unit 70 by the handling system.

Accordingly, while only a few embodiments of the present invention have been shown and described, it is obvious that many changes and modifications may be made thereunto without departing from the spirit and scope of the invention.

### REFERENCE SYMBOL LIST

10 folding unit
12 napkin
14 storage unit (accommodation of folded napkins from folding unit)
16 supply unit (keeping non-folded napkins on hand)
18 transport unit (feed of non-folded napkins from supply unit to folding unit)
20 provisioning unit (keeping flatware on hand for folding unit)
22 flatware
24 withdrawal unit (provisioning unit)
26 deposit unit (provisioning unit)
28 conveying unit (flatware from withdrawal unit to deposit unit)
30 tool system (conveying unit)
29.1 gripping and/or winding system
30.1a roller
30.1b streamer
30.1c gripper
30.2 hold-down system
30.3 bracket system
30.1 paddle
31.2 flatware gripping tool
31.2a magnet unit
31.2b centering device
31.3 slit pipe
31.4 roller unit
31.5 streamer
31.6 gripping unit
32 separate drive (winding system)
34 magazine
36 changing system (conveying unit)
36.1 adapter on handling system side
36.2 adapter on tool side
40 conveyor belt (supply unit)
42 friction coating (folding unit)
44 counter-sinkable fixation unit (folding unit)
46 tool system (transport unit)
46.1 gripping and/or winding system
46.2 bracket system
46.3 hold-down system
46.1a gripping system
46.1b gripping system
46.1c jaw gripping system
48 boxes
48.1, 48.2 stack of boxes
50 storage station (storage unit)
52 filling station (storage unit)
54 intermediate station (storage unit)
56 conveying device (storage unit)
58.1, 58.2 movable base (storage unit)
60 gripping system (conveying device)
60.1 gripper
60.2 gripper accommodation (box)
62 axis (longitudinal axis of conveying device)
64 axis (vertical axis of conveying device)
66 housing (folding device)
68 checking unit
70 banding unit
70.1 unwinding device
70.2 introduction frame
70.3 deposit device
71 banding material
72 intermediate space (between storage unit and supply unit)
74 door (housing)
76 door (housing)
78 door (housing)
80 transverse axis
82 frame construction
82a crossbar (conveying device)
82b guide rail (conveying device)
84 column (conveying device)
86 belt drive (conveying device)
88 press-down unit
88.1 sensor or sensor device
88.2 drive
88.3 linear axis unit
88.4 adapter unit
88.5 guide unit
88.6 slide bearing
88.7 shaft
88.8 equalization element
88.9 adapter element
90 frame construction (transport unit)
92 sensor unit (transport unit)
94 connection unit

What is claimed is:

1. A folding apparatus for folding of non-rigid material parts comprising:
a folding unit adapted for folding of individual non-rigid material parts;
a storage unit adapted for receiving the folded non-rigid material parts from the folding unit;
a supply unit adapted for keeping non-folded non-rigid material parts on hand;
a transport unit that is provided for feeding the non-folded non-rigid material parts from the supply unit to the folding unit; and
a provisioning unit that is provided for keeping set items on hand for the folding unit, the provisioning unit comprising a withdrawal unit for storing of unsorted set items, and a deposit unit for accommodating sorted set items,
wherein the folding apparatus has a conveying unit for conveying the set items from the withdrawal unit to the deposit unit of the provisioning unit, wherein the conveying unit has at least one system selected from the group consisting of a gripping system, a winding system, a hold-down system and a bracket system.

2. The folding apparatus according to claim 1, wherein the system of the conveying unit is configured as a tool system of a handling system.

3. The folding apparatus according to claim 1, wherein the system of the conveying unit is a winding system that is structured as a tool system of a handling system or has a separate drive.

4. The folding apparatus according to claim 2, further comprising a magazine that is provided for provisioning the tool system of the conveying unit.

5. The folding apparatus according to claim 4, wherein the conveying unit has a changing system for changing the tool system provisioned in the magazine.

6. The folding apparatus according to claim 5, wherein the changing system comprises an adapter on a handling system side and an adapter on a tool side.

7. The folding apparatus according to claim 1, wherein the supply unit has a conveyor belt guided along an advancement path in a direction of a longitudinal axis, said conveyor belt being adapted to be filled with non-folded non-rigid material parts.

8. The folding apparatus according to claim 1, wherein the folding unit is configured as a table that is provided with at least one of a friction coating, a counter-sinkable fixation unit, a partial vacuum device, a separation apparatus and a hold-down apparatus.

9. The folding apparatus according to claim 8, wherein the table is adapted to rotate.

10. The folding apparatus according to claim 2, wherein the transport unit has at least one system selected from the group consisting of a gripping system, a winding system, a bracket system and a hold-down system.

11. The folding apparatus according to claim 10, wherein the at least one system of the transport unit is configured as a tool system of a handling system.

12. The folding apparatus according to claim 10, wherein the system of the transport unit is configured as a needle gripping system, a Bernoulli-Venturi gripping system, a Coanda gripping system, a mechanical gripping system, a finger gripping system or a jaw gripping system.

13. The folding apparatus according to claim 10, wherein the system of the transport unit is a gripping system and is connected with a handling system or a frame construction of the folding apparatus by way of a press-down unit.

14. The folding apparatus according to claim 13, wherein the press-down unit has a sensor or a sensor device for recognition of a height of a stack on the conveyor belt.

15. The folding apparatus according to claim 10, wherein the transport unit has a sensor unit for recognition of non-rigid material parts on the conveyor belt.

16. The folding apparatus according to claim 11, wherein the folding unit works together with the tool system of the transport unit or the tool system of the conveying unit.

17. The folding apparatus according to claim 1, wherein the storage unit has stackable boxes to be filled with folded non-rigid material parts.

18. The folding apparatus according to claim 17, wherein the storage unit comprises a storage station that is provided for keeping unfilled boxes on hand and for accommodating filled boxes, a filling station for a box to be currently filled, an intermediate station that is provided for keeping unfilled boxes, and a conveying device that is provided for transporting unfilled boxes from the storage station to the filling station or the intermediate station and for transporting filled boxes to the storage station.

19. The folding apparatus according to claim 18, wherein the boxes are stacked in the storage station.

20. The folding apparatus according to claim 17, wherein at least one box or at least one stack of boxes are accommodated on at least one movable base.

21. The folding apparatus according to claim 18, wherein charging of the storage station with boxes and removal of the boxes from the storage station takes place manually, automatically or semi-automatically.

22. The folding apparatus according to claim 18, wherein the conveying device has a gripping system with grippers that work together with gripper accommodations of the boxes.

23. The folding apparatus according claim 18, wherein the conveying device is attached to a frame construction of the folding apparatus so as to be movable along at least two axes.

24. The folding apparatus according to claim 1, further comprising a checking unit adapted for recognition of flatware.

25. The folding apparatus according to claim 1, further comprising a banding unit that is adapted for banding of folded non-rigid material parts.

26. A method for folding of non-rigid material parts and outfitting of the non-rigid material parts by means of a foldin apparatus that comprises a folding unit that is provided for folding of individual non-rigid material parts, a storage unit that is provided for receiving the folded non-rigid material parts from the folding unit, a supply unit that is provided for keeping non-folded non-rigid material parts available, a transport unit that is provided for feeding the non-folded non-rigid material parts from the supply unit to the folding unit, and/or a conveying unit that is provided for conveying the set items from a withdrawal unit of a provisioning unit that is provided for keeping set items available for the folding unit, to a deposit unit of the provisioning unit, comprising the following steps:
automatically folding the non-rigid material parts and outfitting the non-rigid material parts with at least one set item, wherein at least one gripping or winding system of a handling system is used in the folding unit, the supply unit, the transport unit or the conveying unit, and wherein a robot is used as the handling system.

27. The method according to claim 26, wherein the gripping or winding system of the handling system has a drive that is operated hydraulically, mechanically, pneumatically or electrically and wherein the handling system has an arm that performs rotational movements and linear movements.

28. The method according to claim 26, wherein set items that are present unsorted in the withdrawal unit of the provisioning unit are laid down and sorted in the deposit unit of the provisioning unit, by the conveying unit.

29. The method according to claim 26, further comprising the step of recognizing a set item or a non-rigid material part with a checking unit.

30. The method according to claim 29, wherein the checking unit comprises a camera having an image recognition system, a scanner or one or more optical sensors.

31. The method according to claim 29, wherein the checking unit recognizes a position and type of each of the set items, or a position of the non-rigid material part, and damage or dirt.

32. The method according to claim 31, wherein the checking unit triggers an acoustical or optical alarm or a stop of the folding apparatus when a problem is recognized.

33. The method according to claim 29, wherein the checking unit recognizes incorrect folds and corrects them.

34. The method according to claim 26, further comprising the step of recognizing the non-rigid material parts on the conveyor belt in the transport unit with a sensor unit.

35. The method according to claim 26, wherein the conveying unit has at least one system selected from the group consisting of a gripping system, a winding system, a hold-down system and a bracket system.
